(19) United States
(12) Patent Application Publication
(10) Pub. No.: US 2011/0104337 A1
(43) Pub. Date: May 5, 2011

(54) FEED COMPOSITION FOR CATTLE

(75) Inventors: Vaughn Studer, Manhattan, KS (US); James S. Drouillard, Olsburg, KS (US); Urs Wüest, Kronbuhl (CH); Brandon Depenbusch, Wamego, KS (US); Roland Strabler, Kaisten (CH)

(73) Assignees: Buhler AG, Uzwil (CH); Kansas State University Research Foundation, Manhattan, KS (US)

(21) Appl. No.: 12/303,690

(22) PCT Filed: Oct. 2, 2006
(86) PCT No.: PCT/CH2006/000531

§ 371 Date: Dec. 27, 2010

(30) Foreign Application Priority Data
Jun. 6, 2006 (DE) 10 2006 026 512.2

(51) Int. Cl. A23K 1/16; A23K 1/18; A23K 1/06

(52) U.S. Cl. 426/72

(57) ABSTRACT

A feed composition is for cattle or the like, in particular a fattening feed. The feed composition contains, in addition to conventional components, sorghum and straw, in particular wheat straw, as replacement for maize, alfalfa and hay.

The invention relates to a compound feed for cattle and the like, and in particular for the fattening of cattle.

It is customary to manufacture animal feed by extrusion. The manufacture of a soft, expanded and fatty PET feed with a crumbly structure is thus described in DE-A-2346830, the feed containing a farinaceous and proteinaceous raw material in addition to fat. The ingredients are mixed together and are brought to a moisture content of approx. 20-35% by weight. The mixture is thoroughly kneaded mechanically under increased pressure and is heated to a temperature above 100° C. until the mixture assumes a free-flowing state. The extrusion/expansion process then takes place, so that a feed with an expanded structure and a crumbly texture is produced. In a further extrusion process according to DE-A-3222646, a liquid additive in the expander is sprayed into a mixture, so that the additive diffuses uniformly through the expanded product after the expansion of the mixture.

Described in DE-A-2257108 is a feed which, in addition to cereal grain, also contains hay and silo fodder and a nitrogenous, non-protein substance, for example urea and the like (15-47.5% by weight), as well as a liquid-absorbent inert substance (e.g. betonite). The mixture is heated to a temperature of up to 160° C. under increasing pressure, compressed, and then expanded to produce a gelatinized product having a moisture content of less than 13%. The intention is to achieve a feed with a neutral pH value.

Cattle feed, in particular for the fattening of cattle, exhibits a high proportion of maize, silage and fibres, including hay (which is expensive), among other things in the form of a loose mixture. This feed is ignored selectively by the animal. Only the maize is broken up, for example by steaming and flaking, and the remaining feed components undergo no further preparation.

The object of the invention is to develop a compound feed for cattle and the like, and in particular for fattening, which does not require to be cooled or dried following a pre-treatment, and which is homogeneous, readily digestible and nutritious. The intention is to permit better feed utilization and feed conversion.

The object is achieved with the characterizing features of Patent Claim 1. The maize in the feed in this case can typically be replaced completely by sorghum. Hay can be replaced by straw, and in particular by wheat straw.

Advantageous embodiments are disclosed in the dependent Claims.

The feed can thus be processed mechanically and subjected to short-duration treatment at high temperature, and the treatment can take place in one or several stages.

The feed in the form of agglomerated pellets having a low density should be able to contain 0-50% of straw, in particular wheat straw, in addition to cereal grain, sorghum, molasses, fat, vitamins, water, minerals, fibres and other supplements. In the case of pellets having dimensions of approx. 1-7 cm, the length of the straw or hay fibres can be approx. 1-10 cm.

The ingredients of the feed are mixed, followed by conditioning in the customary manner, and the mixture is then agglomerated into pellets by expansion and short-duration treatment at high temperature, etc. There is no need for subsequent drying or cooling of the dietetic cattle feed produced in this way.

The new product form permits the replacement of conventional feed. This new feed is eaten complete with all of its ingredients and permits better nutritional intake and conversion and, on the other hand, the ability to avoid expensive (e.g. maize or Lucerne) and/or less nutritious (e.g. hay) ingredients. The improved digestibility and conversion of the feed increases the efficiency with which the cattle are fattened. It is also possible to replace lucerne with straw, in particular wheat straw.

In addition, the use of sorghum instead of maize produces a smaller loading on the environment, because sorghum requires significantly less water for the growth of the plant.

Both starter products with a high proportion of fibre and fattening feeds with a very low proportion of straw fibres can be produced, since the form of the pellets is able to adopt the sole purpose of hay and straw fibres in the rumen (mechanical irritation). The use of such fibres can thus be dispensed with entirely.

The invention is described below in greater detail as an illustrative embodiment.

A premix of cereal grain ingredients, vitamins, minerals and/or other supplements is mixed in a mixer and makes its way into a dosing balance.

From there, the mixture makes its way, with the addition of water 6 and steam 5, into a further device for mechanical/thermal treatment, into which additional supplements such as wheat straw, fat and molasses can also be introduced. The conditioned mixture is then agglomerated into pellets having low density and high porosity.

The pellets produced by way of example exhibit a density of 300-600 g/l and contain approx. 0-50% straw. The water content is 18-25%. The length of the straw fibres in the pellet is in the order of 1-7 cm.

The pellets exhibit dimensions of approx. 1-7 cm and are very suitable for use as concentrated feeding stuffs and exhibit only a small fine fraction. The sugar and starch ingredients are gelatinized and bind the other ingredients together.

Compound feeds are mentioned below as examples:

A. Maintenance Feed
Cereals, 30-60%
Raw fibres (straw, hay and the like), 20-50%

Distillers' grain (cereal draff), up to 20%
Molasses or corn steep liquor, up to 5%
Urea, up to 1%
Soy flour, 2-4%
Vitamins/mineral premix, 1%

B. Fattening Feed
Cereals, 78-85%
Raw fibres (straw, hay and the like), 3-8%
Distillers' grain (cereal draff), up to 25%
Molasses or corn steep liquor, 3-6%
Suet, 2-4%
Urea, up to 1.5%
Soy flour, 2-4%
Vitamins

The form and porosity of the pellets have the same effect as the previous use of hay or straw.

As a result of the better conversion, the feed also produces a lower yield of dung and liquid manure.

1. Compound feed for cattle and the like, which is treated mechanically and thermally and is formed into agglomerated pellets and contains water, cereal grain components, fat, molasses, vitamins, minerals and/or other supplements together with 3-50% of straw, the cereal grain and starch components comprising sorghum, and the straw being present as wheat straw with a proportion of up to 50% in the compound feed and the straw fibers exhibiting a length of 1-7 cm in the pellet.

2. Compound feed according to claim 1, wherein the density of the pellets is 300-600 g/l.

3. Compound feed according to claim 1, wherein the water content is 18-25%.

4. Application for a compound feed according to claim 1, wherein the compound feed is used as a starter feed and contains up to 50% of straw, in particular wheat straw.

5. Application for a compound feed according to claim 1, wherein the compound feed is used as a rearing feed and only contains a maximum of 8% of straw.

6. (canceled)
